(19) United States
(12) Patent Application Publication
(10) Pub. No.: US 2026/0200351 A1
(43) Pub. Date: Jul. 16, 2026

(54) MULTIFUNCTIONAL POWER CONVERTERS AND CONTROL FOR MIXED CHEMISTRY BATTERY PACKS

(71) Applicant: GM GLOBAL TECHNOLOGY OPERATIONS LLC, Detroit, MI (US)

(72) Inventors: Jian YAO, Shanghai (CN); Chengwu DUAN, Shanghai (CN); Lei HAO, Shelby Township, MI (US)

(21) Appl. No.: 19/420,537

(22) Filed: Dec. 15, 2025

(30) Foreign Application Priority Data
Jan. 14, 2025 (CN) 2025100561697

(51) Int. Cl. B60L 53/22; B60L 53/12; H02J 7/00; H02J 7/50; H02M 3/335

(52) U.S. Cl. CPC B60L 53/22; B60L 53/12; H02J 7/485; H02J 7/50; H02J 7/855; H02J 7/865; H02M 3/33576; B60L 2210/10

(57) ABSTRACT

A power system includes a power converter configured to couple between a power source and a battery assembly having battery modules with different chemistries. The power converter includes at least one branch having an inductance. The power system further includes a switching device coupled between the at least one branch of the power converter and a node between the battery modules, and a control module configured to selectively control the switching device to cause the power converter to operate in a first mode in which the branch of the power converter is coupled across the battery assembly and a second mode in which the branch of the power converter is coupled to the node between the battery modules of the battery assembly. Other example power systems and control methods are also disclosed.

### CROSS-REFERENCE TO RELATED APPLICATIONS

This application claims the benefit of Chinese Patent Application No. 202510056169.7, filed on January 14, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to multifunctional power converters and control for mixed chemistry battery packs.

Electric vehicles (EVs) such as battery electric vehicles (BEVs), hybrid vehicles, and/or fuel cell vehicles include one or more electric machines and a battery system including one or more battery cells. The battery cells can be arranged in battery modules including two or more battery cells and/or in battery packs including two or more battery modules. Sometimes, the battery system includes mixed chemistry battery cells having different chemical compositions. A power control system is used to control charging and/or discharging of the battery system. Specifically, an onboard charger (OBC) power converter may receive power from an external source via a charger plug and provide power for charging a high voltage battery system in the vehicle. In scenarios where mixed chemistry battery cells are employed, a different power converter is used for charging the battery cells with different chemical compositions.

### SUMMARY

A power system for controlling power transfer in a vehicle, includes a multifunctional direct current-direct current (DC-DC) power converter configured to couple between a power source and a mixed chemistry battery assembly having a first battery module with a first chemistry and a second battery module with a second chemistry different than the first chemistry. The power converter includes a first stage configured to couple to the power source and a second stage configured to couple to the mixed chemistry battery assembly. The second stage includes at least one branch having an inductance. The power system further includes a switching device coupled between the at least one branch of the power converter and a node between the first battery module and the second battery module of the mixed chemistry battery assembly, and a control module configured to selectively control the switching device to cause the power converter to operate in a first mode in which the at least one branch of the power converter is coupled across the mixed chemistry battery assembly and a second mode in which the at least one branch of the power converter is coupled to the node between the first battery module and the second battery module of the mixed chemistry battery assembly.

In other features, the second stage includes a transformer coupled between the at least one branch and the first stage.

In other features, the switching device is a first switching device, the first stage includes a plurality of second switching devices coupled between the transformer and the power source, and the control module is configured to open the plurality of second switching devices when the power converter to operating in the second mode.

In other features, the at least one branch is a first branch and the inductance is a first inductance, the second stage includes a second branch having a second inductance, and the switching device is coupled between the first and second branches and the node of the mixed chemistry battery assembly.

In other features, the at least one branch is a first branch and the inductance is a first inductance, and the second stage includes a second branch having a second inductance and a third branch having a third inductance.

In other features, the switching device is coupled between the first, second and third branches and the node of the mixed chemistry battery assembly.

In other features, the switching device is coupled between the first and second branches and the third branch and the node of the mixed chemistry battery assembly.

In other features, the power converter is configured to simultaneously operate in the first mode and the second mode.

In other features, the control module configured to move the switching device to a first position to cause the power converter to operate in the first mode and to move the switching device to a second position to cause the power converter to operate in the second mode.

In other features, the control module configured to open the switching device to cause the power converter to operate in the first mode and to close the switching device to cause the power converter to operate in the second mode.

In other features, the power converter is configured to transfer power from one of the first battery module and the second battery module to the other one of the first battery module and the second battery module when operating in the second mode.

In other features, the power converter is configured to charge the first battery module and the second battery module of the mixed chemistry battery assembly via power from the power source when operating in the first mode.

In other features, the power converter is configured to discharge power from the first battery module and the second battery module of the mixed chemistry battery assembly to the power source when operating in the first mode.

A power system for controlling power transfer in a vehicle, includes a high voltage power source, a mixed chemistry battery assembly having a first battery module with a first chemistry and a second battery module with a second chemistry different than the first chemistry, and a multifunctional DC-DC power converter including a first stage coupled to the high voltage power source and a second stage coupled to the mixed chemistry battery assembly. The second stage includes at least one branch having an inductance and a transformer coupled between the at least one branch and the first stage. The power system further includes a switching device coupled between the at least one branch of the power converter and a node between the first battery module and the second battery module of the mixed chemistry battery assembly, and a control module configured to selectively control the switching device to couple the at least one branch across the mixed chemistry battery assembly to charge the first battery module and the second battery module via power from the high voltage power source and to couple the at least one branch to the node between the first battery module and the second battery module to transfer power from one of the first battery module and the second battery module to the other one of the first battery module and the second battery module.

In other features, the switching device is a first switching device, the first stage includes a plurality of second switching devices coupled between the transformer and the high voltage power source, and the control module configured to open the plurality of second switching devices when power is transferred from one of the first battery module and the second battery module to the other one of the first battery module and the second battery module.

In other features, the at least one branch is a first branch and the inductance is a first inductance, the second stage includes a second having a second inductance, and the first switching device is coupled between the first and second branches and the node of the mixed chemistry battery assembly.

In other features, the at least one branch is a first branch and the inductance is a first inductance, and the second stage includes a second having a second inductance and a third branch having a third inductance.

In other features, the first switching device is coupled between the first, second and third branches and the node of the mixed chemistry battery assembly.

In other features, the first switching device is coupled between the first and second branches and the third branch and the node of the mixed chemistry battery assembly, and the power converter is configured to simultaneously charge the first battery module and the second battery module via power from the high voltage power source and transfer power from one of the first battery module and the second battery module to the other one of the first battery module and the second battery module.

A power system for controlling power transfer in a vehicle, includes a low voltage battery pack, a mixed chemistry battery assembly having a first battery module with a first chemistry and a second battery module with a second chemistry different than the first chemistry, and a multifunctional DC-DC power converter configured to couple between the low voltage battery pack and the mixed chemistry battery assembly. The power converter includes a first stage coupled to the low voltage battery pack and a second stage isolated from the first stage and coupled to the mixed chemistry battery assembly. The second stage includes at least one branch having an inductance. The power system further includes a switching device coupled between the at least one branch of the power converter and a node between the first battery module and the second battery module of the mixed chemistry battery assembly, and a control module configured to selectively control the switching device to couple the at least one branch across the mixed chemistry battery assembly to discharge power from the first battery module and the second battery module to the low voltage battery pack and to couple the at least one branch to the node between the first battery module and the second battery module to transfer power from one of the first battery module and the second battery module to the other one of the first battery module and the second battery module.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example power system having a multifunctional direct current-direct current (DC-DC) power converter coupled between a power source and a mixed chemistry battery assembly, according to the present disclosure;

FIG. 2 is a vehicle including portions of the power system of FIG. 1, according to the present disclosure;

FIGS. 3-7 are block diagrams of example multifunctional DC-DC power converters employable in the power system of FIG. 1, according to the present disclosure; and

FIG. 8 is a flowchart of example control process for controlling power transfer with a multifunctional DC-DC power converter, according to the present disclosure.

In the drawings, reference numbers may be reused to identify similar and/or identical elements.

### DETAILED DESCRIPTION

Electric vehicles (EVs) such as battery electric vehicles (BEVs), hybrid vehicles, and/or fuel cell vehicles include one or more electric machines, a battery system including one or more battery cells, and a power system for controlling charging and/or discharging of the battery system. In such examples, the power system includes separate power converters for charging and/or discharging high voltage battery cells and battery cells having different chemical compositions. Specifically, an onboard charger (OBC) power converter is often employed to provide power to high voltage battery cells from an external source via a charger plug. A separate power converter having one or more inductive branches is often used to charge and/or discharge mixed chemistry battery cells.

The power systems and methods according to the present disclosure implement novel architectures of multifunctional direct current-direct current (DC-DC) power converters for charging and/or discharging serial mixed chemistry battery cells, such as in a battery pack or module. In such architectures, OBC power converter circuitry or auxiliary power module (APM) power converter circuitry and power converter circuitry for mixed chemistry battery cells may be integrated into a multifunctional DC-DC power converter. In such examples, the multifunctional DC-DC power converter can be controlled to operate in different modes to charge the battery cells via a high voltage power source, to discharge power from the battery cells to a low voltage power source, and/or to provide active energy movement between the battery cells. By reusing and integrating circuitry, such as switching devices, inductors, capacitors, etc. of the OBC power converter/APM power converter to function as a DC-DC converter for active energy movement, the amount of power electronic components and costs associated therewith are greatly reduced.

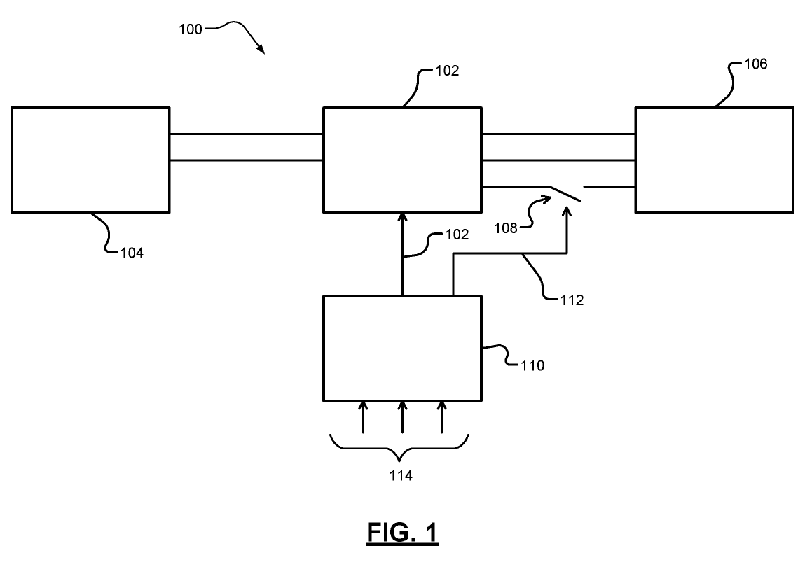

Referring now to FIG. 1, a block diagram of an example power system 100 is presented for controlling power transfer. As shown in FIG. 1, the power system 100 generally includes a multifunctional DC-DC power converter 102, a switching device 108, and a control module 110. More specifically, the multifunctional DC-DC power converter 102 is coupled between a power source 104 and a mixed chemistry battery assembly 106, and the switching device 108 is coupled between the multifunctional DC-DC power converter 102 and the mixed chemistry battery assembly 106.

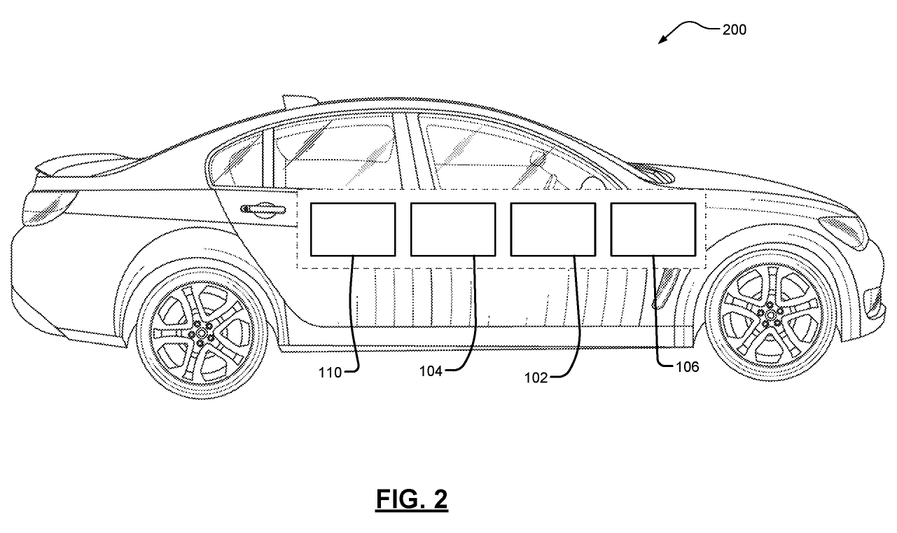

The power system 100 of FIG. 1 may be employable in any suitable application benefiting from multifunctional operation. For example, the power system 100 may be employable as a power system for a vehicle, such as an electric vehicle (e.g., a pure electric vehicle, a plug-in hybrid electric vehicle, etc.). Additionally, the system 100 may be applicable to an autonomous vehicle, a semi-autonomous vehicle, etc. For example, FIG. 2 depicts a vehicle 200 including the DC-DC power converter 102, the power source 104, the mixed chemistry battery assembly 106, and the control module 110 of FIG. 1.

While continued reference to FIG. 1, the mixed chemistry battery assembly 106 may be any suitable collection of battery cells for driving a vehicle, such as the vehicle 200 of FIG. 2. For example, the mixed chemistry battery assembly 106 may include a first battery module with a first chemistry and a second battery module with a second, different chemistry. More specifically, the first battery module may include one or more first battery cells having a chemical composition and the second battery module with one or more second battery cells having another, different chemical composition. In various embodiments, the first battery cell(s) may have a lithium-nickel-cobalt-manganese oxide (NMC) composition or another suitable chemical composition, and the second battery cell(s) may have a lithium ferrophosphate (LFP) composition or another suitable chemical composition.

In the example of FIG. 1, the battery modules of the mixed chemistry battery assembly 106 may be coupled together and form a mixed chemistry pack. For example, the first battery module and the second battery module may be coupled in series. In such examples, a node exists between the battery modules (e.g., between the first battery cell(s) and the second battery cell(s)). With this configuration, the first battery module (or the first battery cell(s)) may be coupled to a positive terminal of the mixed chemistry battery assembly 106 and the second battery module (or the second battery cell(s)) may be coupled to a reference (e.g., negative) terminal of the mixed chemistry battery assembly 106, or vice versa.

Additionally, the switching device 108 of FIG. 1 may be any suitable switching device. For example, the switching device 108 may be a solid-state device (e.g., a mechanical relay, an electromagnetic relay, etc.), an active device (e.g., a field-effect transistor (FET), a metal-oxide-semiconductor field-effect transistor (MOSFET), etc.), etc. Further, the switching device 108 may be a component external to and separate from the power converter 102 as shown in FIG. 1, or a component within the power converter 102. As such, the switching device 108 may be generally positioned between the power converter 102 and the mixed chemistry battery assembly 106, and more specifically, coupled between at least one branch of the power converter 102 (as further explained below) and the node between the serial battery modules of the mixed chemistry battery assembly 106.

The power source 104 may include or represent various different components. For instance, the power source 104 may include a power factor correction (PFC) power converter for providing high DC voltage (e.g., 400 VDC, 800 VDC, etc.) to the power converter 102. In such examples, the PFC power converter receives AC voltage from a charging station (via a charger plug and then converts the AC voltage into the high DC voltage for the power converter 102, which then provides power to the mixed chemistry battery assembly 106. In other examples, the power source 104 may include, for example, one or more low voltage battery modules (or packs). In such examples, the one or more low voltage battery modules may receive low DC voltage (e.g., 12 VDC, 48 VDC, etc.) from the mixed chemistry battery assembly 106 via the power converter 102, as further explained herein.

In various embodiments, the multifunctional DC-DC power converter 102 may include multiple power stages. In such examples, one stage (e.g., a first stage) may couple to the power source 104 and another stage (e.g., a second stage) may couple to the mixed chemistry battery assembly 106. In some examples, the stages may be isolated from each other via an isolation component, such as a transformer. With this arrangement, the first stage coupled to the power source 104 may include, for example, four switching devices (e.g., MOSFETs, diodes, etc.) in a full-bridge configuration, and the second stage may include, for example, one or more inductive branches for coupling to the mixed chemistry battery assembly 106 based on the position (e.g., location) and state (e.g., open or closed) of the switching device 108. For instance, each branch may include at least one inductance (e.g., an inductor, a coupled inductor, a transformer winding, etc.) coupled to the switching device 108 and/or the node between the serial battery modules of the mixed chemistry battery assembly 106.

In the example of FIG. 1, the control module 110 selectively controls the switching device 108 to cause the power converter 102 to operate different modes. In such examples, the control module 110 may generate a control signal 112 for controlling the switching device 108. In some examples, the control signal 112 may close a normally open switch, or open a normally closed switch. In various embodiments, the control signal 112 for controlling the switching device 108 may be generated based on one or more inputs 114 received by the control module 110. For example, the control module 110 may receive a user input specifying a selected operating mode. In other examples, the control module 110 may receive sensed parameters associated with the battery modules of the mixed chemistry battery assembly 106, the power source 104, etc. In such examples, the control module 110 may select an appropriate mode based on such input(s). For instance, based on the received input(s) 114, the control module 110 may determine the power source 104 (e.g., PFC power converter) is not connected to a charging station, the power source 104 is not receiving input power, the vehicle is moving (e.g., being driven), the state of charges (SOC) of the battery modules are undesirable (e.g., below threshold(s), unbalanced, etc.), etc. Then, the control module 110 can control the switching device 108 to cause the power converter 102 to operate in a particular mode based on the received input(s) 114.

For example, the control module 110 may control the switching device 108 to open to cause the power converter 102 to operate in one operating mode. In this operating mode, at least one inductive branch (and sometimes all branches) of the power converter 102 may be coupled across the mixed chemistry battery assembly 106 due to the position and the state of the switching device 108. In other words, in this operating mode, the at least one inductive branch (and more generally, the power converter 102) is coupled across the serial battery modules of the mixed chemistry battery assembly 106 to provide power to the mixed chemistry battery assembly 106. In such examples, the power converter 102 may function as an OBC for charging the battery modules of the mixed chemistry battery assembly 106 via power from the power source 104 or an APM for discharging power from the battery modules of the mixed chemistry battery assembly 106 to the power source 104.

In other examples, the control module 110 may control the switching device 108 to close to cause the power converter 102 to operate in another operating mode (e.g., a second operating mode). In this operating mode, at least one inductive branch (and sometimes all branches) of the power converter 102 may be coupled to the node between the serial battery modules of the mixed chemistry battery assembly 106 due to the position and the state of the switching device 108. In such examples, the power converter 102 may function in an energy movement mode in which power may be transferred from one battery module to another battery module of the mixed chemistry battery assembly 106. In various embodiments, the switching devices of the first stage of the power converter 102 may be open, disabled, etc. to ensure the power source 104 is effectively disconnected from the second stage of the power converter 102. In other words, no power is provided or received by in the first stage of the power converter 102 when operating in the second mode.

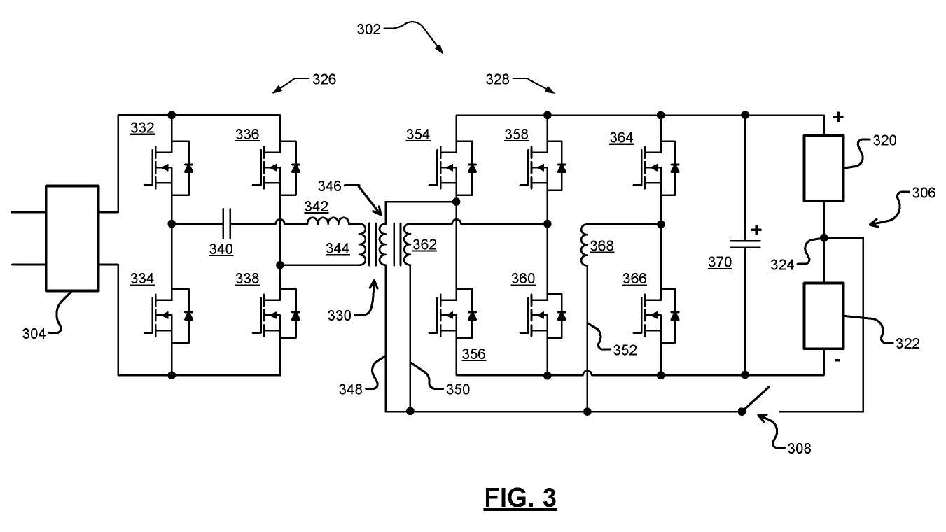

FIGS. 3-7 depict various examples of power converters 302, 402, 502, 602, 702 any of which may be employable as the multifunctional DC-DC power converter 102 of FIG. 1. While specific examples of converter circuitry for the power converter 102 of FIG. 1 are shown in FIGS. 3-7, it should be appreciated that the power converter 102 is not limited to the examples of FIGS. 3-7. As such, the power converter 102 may include another suitable converter circuitry if desired.

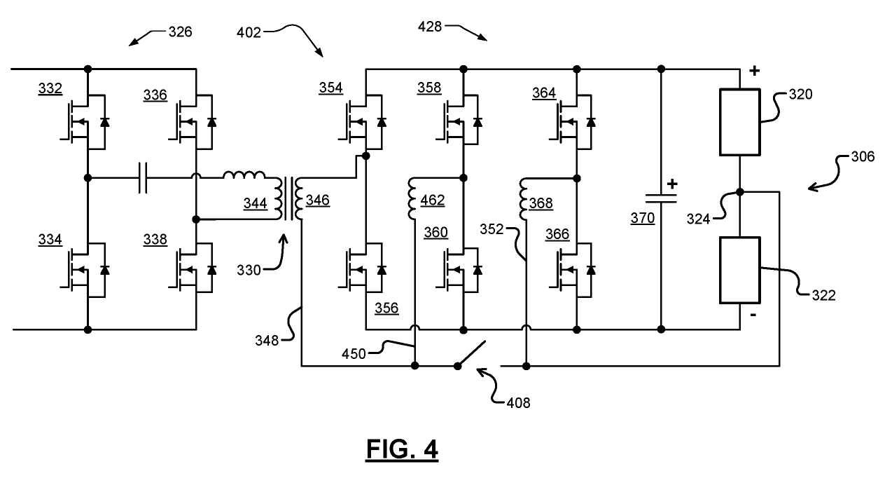

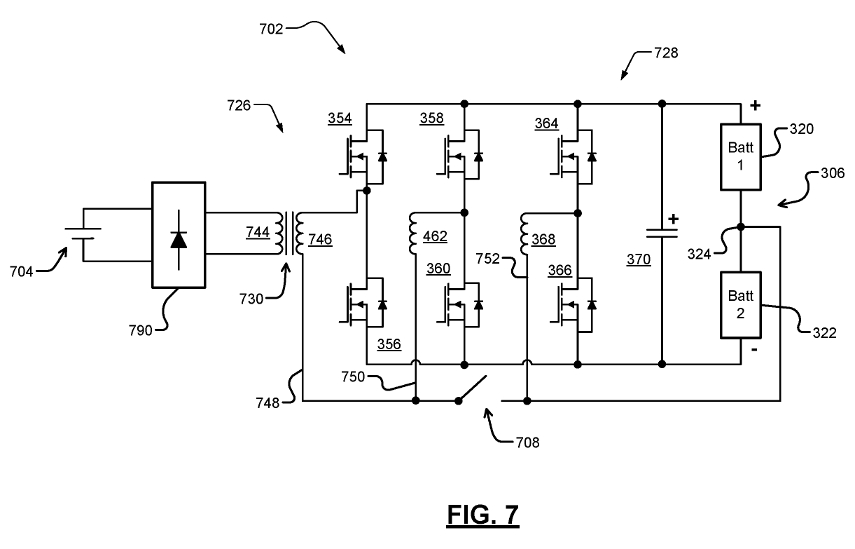

The power converters 302, 402, 502, 602, 702 of FIGS. 3-7 are each generally coupled between a power source and a mixed chemistry battery assembly, as explained above. Specifically, in FIGS. 3-6, the power converters 302, 402, 502, 602 are coupled between a PFC power converter 304 (not shown in FIGS. 4-6) and a mixed chemistry battery assembly 306. In such examples, the mixed chemistry battery assembly 306 includes battery modules 320, 322 coupled in series with a node 324 therebetween. The battery modules 320, 322 have battery cell(s) of different chemical composition. For instance, the battery cell(s) of the battery module 320 may have a lithium-nickel-cobalt-manganese oxide (NMC) composition or another suitable chemical composition, and the battery cell(s) of the battery module 322 may have a lithium ferrophosphate (LFP) composition or another suitable chemical composition. In FIG. 7, the power converter 702 is coupled between a low voltage battery module (or pack) 704 and the mixed chemistry battery assembly 306 of FIGS. 3-6.

In FIG. 3, the power converter 302 includes stages 326, 328 and a transformer 330. In various embodiments, the transformer 330 may be a portion of the stage 326 or the stage 328, or may include portions in both stages 326, 328. For example, if the transformer 330 is part of the stage 328, the transformer 330 may be coupled between branches in the stage 328 (as explained below) and the stage 326.

The stage 326 includes four MOSFETs 332, 334, 336, 338 in a full-bridge configuration. The MOSFETs 332, 334, 336, 338 are each shown with an intrinsic body diode. In this example, the MOSFETs 332, 334 are coupled to the PFC power converter 304 and to a primary winding 344 of the transformer 330 via a capacitor 340 and an inductor 342. The MOSFETs 336, 338 are coupled to the MOSFETs 332, 334 and a secondary winding 346 of the transformer 330.

The stage 328 includes MOSFETs 354, 356, 358, 360, 364, 366 coupled across the battery assembly 306 via a capacitor 370. In this example, the MOSFETs 354, 356, 358, 360, 364, 366 form portions of three inductive branches 348, 350, 352, which are generally coupled between the transformer 330 and the mixed chemistry battery assembly 306. Each branch 348, 350, 352 includes at least one inductance. For example, in FIG. 3, the branch 348 includes two MOSFETs 354, 356 and the secondary winding 346 of the transformer 330 coupled therebetween. Likewise, the branch 350 includes two MOSFETs 358, 360 and an inductor 362 coupled therebetween, and the branch 352 includes two MOSFETs 364, 366 and an inductor 368 coupled therebetween. In this example, the inductor 362 is a coupled inductor sharing a core with the windings 344, 346 of the transformer 330.

As shown in FIG. 3, the power converter 302 further includes a switching device 308 representing the switching device 108 of FIG. 1. In FIG. 3, the switching device 308 is coupled between the branches 348, 350, 352 and the node 324 between the battery modules 320, 322. More specifically, the switching device 308 is coupled to the inductance (e.g., the secondary winding 344, the coupled inductor 362, and the inductor 368) of each branch 348, 350, 352 and the node 324.

In FIG. 3, the power converter 302 may operate in different modes based on a state of the switching device 308. For example, when the switching device 308 is open, the power converter 302 (e.g., the branches 348, 350, 352) is coupled across the mixed chemistry battery assembly 306 to charge the battery modules 320, 322 via power from the PFC power converter 304 (e.g., a high voltage power source). This configuration may be referred to as an OBC mode. During this mode, the control module 110 may control the MOSFETs 332, 334, 336, 338 of the stage 326 and/or the MOSFETs 354, 356, 358, 360, 364, 366 of the stage 328 to charge the battery modules 320, 322. Such control may be based on the input(s) 114 representing sensed parameters (e.g., voltages, currents, etc.) associated with the battery modules 320, 322, the stages 326, 328, the power source 304, etc.

In other scenarios, the switching device 308 may be closed to enable the power converter 303 to operate in an energy movement mode. For example, when the switching device 308 is closed, the three branches 348, 350, 352 are coupled to the node 324 (via the inductances) to allow for transfer of power from one of the battery modules 320, 322 to the other battery module 320, 322. In such examples, two parallel loops in the stage 328 are created. One loop includes the MOSFETs 354, 356, the secondary winding 346, and the MOSFET 366, and the other loop includes the MOSFETs 358, 360, the coupled inductor 362, and the MOSFET 366. During the energy movement mode, the MOSFETs 332, 334, 336, 338 of the stage 326 are open (or disabled), and the MOSFETs 354, 356, 358, 360, 364, 366 of the stage 328 are controlled by the control module 110 as desired.

In FIG. 4, the power converter 402 is similar to the power converter 302 but includes a switching device 408 in a different location as compared to the switching device 308 of FIG. 3. For example, the power converter 402 includes the stage 326 of FIG. 3 with the MOSFETs 332, 334, 336, 338 coupled to the primary winding 344 of the transformer 330. The power converter 402 further includes a stage 428 similar to the stage 328 of FIG. 3 but with a different configuration.

For example, the stage 428 includes the MOSFETs 354, 356, 358, 360, 364, 366 of FIG. 3 coupled across the battery assembly 306 via the capacitor 370, the inductor 368 of FIG. 3, and an inductor 462. In FIG. 4, the MOSFETs 354, 356, 358, 360, 364, 366 form portions of three inductive branches 348, 450, 352. For example, in FIG. 4, the branch 348 includes the MOSFETs 354, 356 and the secondary winding 346 of the transformer 330, the branch 450 includes the MOSFETs 358, 360 and the inductor 462 coupled therebetween, and the branch 352 includes the MOSFETs 364, 366 and the inductor 368 coupled therebetween.

As shown in FIG. 4, the switching device 408 is coupled between the branches 348, 450 and the node 324. More specifically, the switching device 408 is coupled between the branches 348, 450, and the branch 352 and the node 324.

The power converter 402 of FIG. 4 operates in different modes in a similar manner as explained above relative to the power converter 302 of FIG. 3. For example, when the switching device 408 is open, the power converter 402 operates in an OBC mode in which the power converter 402 is coupled across the mixed chemistry battery assembly 306 to charge the battery modules 320, 322 via power from the PFC power converter (not shown). When the switching device 408 is closed, the power converter 402 operates in an energy movement mode in which the branches 348, 450, 352 are coupled to the node 324 (via the inductances) to allow for power transfer between the battery modules 320, 322.

Additionally, the power converter 402 may simultaneously operate in both the OBC mode and the energy movement mode. For example, due to the location of the switching device 408, the branch 352 is coupled to the node 324 regardless of the state of the switching device 408. As such, when the power converter 402 operates in the OBC mode, power may be transferred between the battery modules 320, 322 via the branch 352 when the switching device 408 is open.

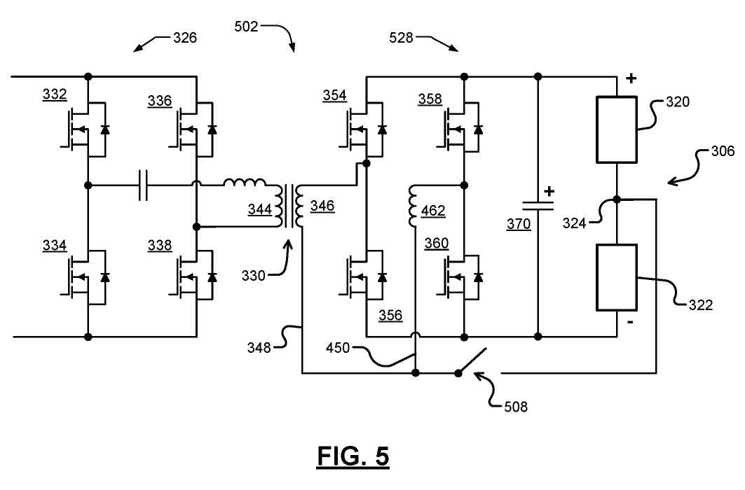

In FIG. 5, the power converter 502 is similar to the power converter 402 of FIG. 4 but includes only two inductive branches. For example, the power converter 502 includes the stage 326 of FIG. 3 with the MOSFETs 332, 334, 336, 338 coupled to the primary winding 344 of the transformer 330. The power converter 502 further includes a stage 528 similar to the stage 428 of FIG. 4 but with two inductive branches.

Specifically, in FIG. 5, the stage 428 includes the MOSFETs 354, 356, 358, 360 of FIG. 3 coupled across the battery assembly 306 via the capacitor 370, and the inductor 462 of FIG. 4. In this example, the MOSFETs 354, 356, 358, 360 form portions of two inductive branches 348, 450. For example, in FIG. 5, the branch 348 includes the MOSFETs 354, 356 and the secondary winding 346 of the transformer 330, and the branch 450 includes the MOSFETs 358, 360 and the inductor 462 coupled therebetween.

As shown in FIG. 5, a switching device 508 is coupled between the branches 348, 450 and the node 324. The power converter 502 operates in different modes based on the state of the switching device 508, as explained above relative to FIGS. 3-4. For example, when the switching device 508 is closed, the power converter 502 operates in an OBC mode in which the power converter 502 is coupled across the mixed chemistry battery assembly 306 to charge the battery modules 320, 322 via power from the PFC power converter (not shown). When the switching device 508 is open, the power converter 502 operates in an energy movement mode in which the branches 348, 450 are coupled to the node 324 to allow for power transfer between the battery modules 320, 322.

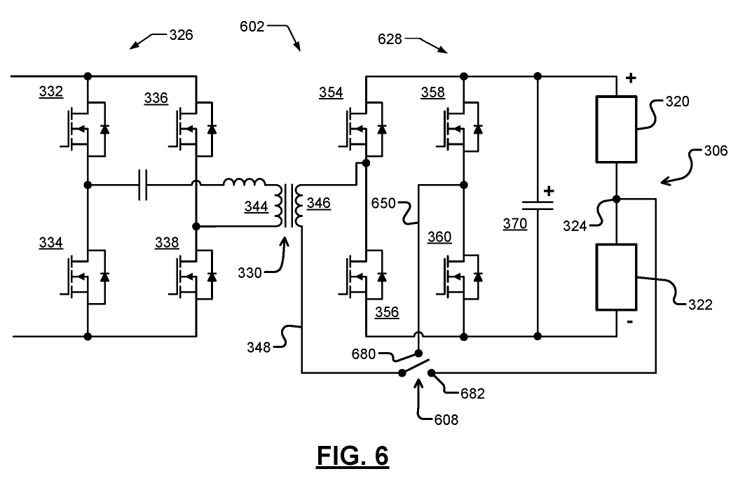

The power converter 602 of FIG. 6 is similar to the power converter 502 of FIG. 5 but with a different switching device. For example, the power converter 602 includes the stage 326 of FIG. 3 with the MOSFETs 332, 334, 336, 338 coupled to the primary winding 344 of the transformer 330. The power converter 602 further includes a stage 628 similar to the stage 528 of FIG. 5 but with a relay 608 and only one inductive component.

Specifically, in FIG. 6, the stage 628 includes the MOSFETs 354, 356, 358, 360 of FIG. 3 coupled across the battery assembly 306 via the capacitor 370. The MOSFETs 354, 356, 358, 360 form portions of two branches 348, 650. For example, in FIG. 6, the branch 348 includes the MOSFETs 354, 356 and the secondary winding 346 of the transformer 330, and the branch 650 includes the MOSFETs 358, 360.

As shown in FIG. 6, the relay 608 is coupled between one of the branches 348, 650 and the node 324. Then, based on the position of the relay 608, the power converter 602 may operates in different modes. For example, the relay 608 may be moved to different positions in which the secondary winding 346 is coupled to a node 680 or a node 682. When the secondary winding 346 is coupled to the node 680, the power converter 602 operates in an OBC mode in which the power converter 602 is coupled across the mixed chemistry battery assembly 306 to charge the battery modules 320, 322 via power from the PFC power converter (not shown). However, when the secondary winding 346 is coupled to the node 682, the power converter 602 operates in an energy movement mode in which the branch 348 is coupled to the node 324 to allow for power transfer between the battery modules 320, 322.

The power converter 702 of FIG. 7 is similar to the power converter 402 of FIG. 4 but with APM circuitry for providing power to the low voltage battery module 704. For example, the power converter 702 generally includes stages 726, 728. In FIG. 7, the stage 728 includes the MOSFETs 364, 366 and the inductor 368 of FIG. 4. The stage 726 includes the MOSFETs 354, 356, 358, 360 of FIG. 4, the inductor 462 of FIG. 4, a transformer 730, and a rectifying circuit 790 coupled between the low voltage battery module 704 and the transformer 730. Specifically, the rectifying circuit 790 is coupled to a secondary winding 744 of the transformer 730, and the MOSFETs 354, 356 are coupled to a primary winding 746 of the transformer 730. In this example, the MOSFETs 354, 356, 358, 360 and the transformer 730 function as a primary side of the APM circuitry and the rectifying circuit 790 functions as a secondary side of the APM circuitry.

As shown in FIG. 7, the power converter 702 incudes three inductive branches 748, 750, 752 similar to the branches 348, 450, 352 of FIG. 4. For instance, the branch 748 includes the MOSFETs 354, 356 and the primary winding 746 of the transformer 730, the branch 750 includes the MOSFETs 358, 360 and the inductor 462 coupled therebetween, and the branch 752 includes the MOSFETs 364, 366 and the inductor 368 coupled therebetween.

Additionally, a switching device 708 is coupled in a similar position as the switching device 408 of FIG. 4. Specifically, in FIG. 7, the switching device 708 is coupled between the branches 748, 750 and the node 324 and the branch 752. With this configuration, the power converter 702 may operate in different modes based on the state of the switching device 708.

For example, when the switching device 708 is open, the power converter 702 (e.g., the branches 748, 750) is coupled across the mixed chemistry battery assembly 306 to discharge power from the battery modules 320, 322 to the low voltage battery module 704. In such examples, the MOSFETs 354, 356, 358, 360, 364, 366 and optional switching devices of the rectifying circuit 790 may be controlled by the control module 110 (not shown in FIG. 7) as desired.

Alternatively, when the switching device 708 is closed, the branches 748, 750, 752 are coupled to the node 324 to transfer power between the battery modules 320, 322, as explained herein. During this energy movement mode, the rectifying circuit 790 may be disabled and the MOSFETs 354, 356, 358, 360, 364, 366 may be controlled by the control module 110 as desired.

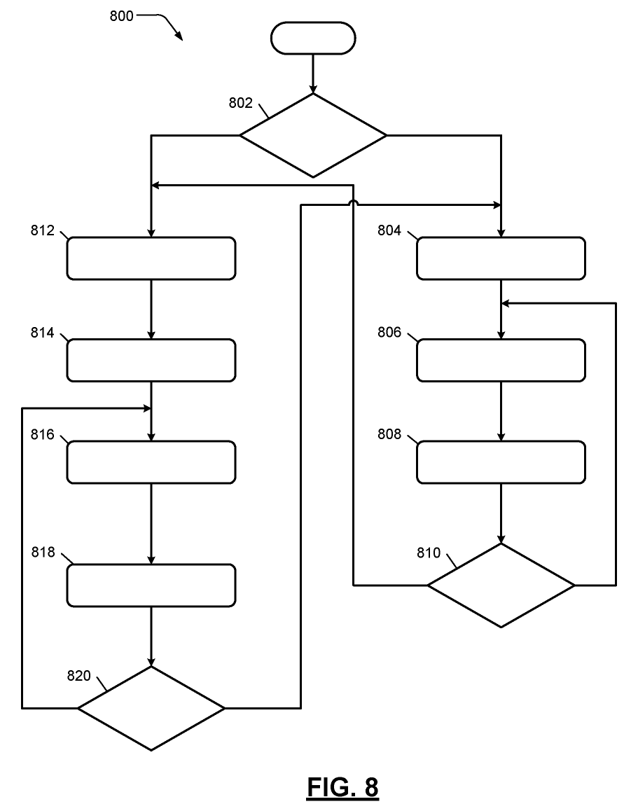

FIG. 8 illustrates an example control method 800 employable by the power system 100 of FIG. 1 including for controlling power transfer with the multifunctional DC-DC power converter 302 of FIG. 3. Although the example control method 800 is described in relation to the power system 100 of FIG. 1 including the control module 110 and the power converter 302 of FIG. 3, the control method 800 may be employable by another suitable system and/or multifunctional DC-DC power converter.

As shown in FIG. 8, the control method 800 begins at 802 by determining the current operating mode of the power system 100. For example, the control module 110 may determine whether the power system 100 is operating in an OBC mode (e.g., an OBC charging mode). In such examples, the control module 110 may receive one or more inputs (e.g., user input, sensed input, etc.) indicating the power system 100 is in an OBC mode. For instance, the control module 110 may receive an input indicating the power source 304 is connected to a charging station or receiving power. In other examples, the control module 110 may determine whether the power system 100 is operating in an energy movement mode based on an input indicating the power source 304 is not connected to a charging station or receiving power, the vehicle is moving (e.g., being driven), etc. If the power system 100 is operating in an OBC mode (yes at 802), the control method 800 proceeds to 804. If, however, the power system 100 is not operating in an OBC mode at 802, the control method 800 proceeds to 812.

At 804, the control module 110 controls the switching device 308 of FIG. 3 to open. For example, and as explained above, the control module 110 may generate and transmit a control signal (e.g., the control signal 112) to the switching device 308 for control purposes. The control method 800 then proceeds to 806, where the control module 110 monitors one or more battery characteristics associated with the mixed chemistry battery assembly 306. For example, based on sensed inputs, the control module 110 may determine and/or monitor a SOC of each battery module 320, 322 in the mixed chemistry battery assembly 306, a voltage of each battery module 320, 322, a temperature of each battery module 320, 322, etc. Then, the control method 800 proceeds to 808. At 808, the control module 110 controls the switching devices (e.g., the MOSFETs 354, 356, 358, 360, 364, 366) in the stage 328 of the power converter 302 based on the monitored battery characteristic(s). The control method 800 then proceeds to 810.

At 810, the control module 110 determines whether to operate the power system 100 in an energy movement mode or control. For example, the control module 110 may receive one or more inputs to indicate the vehicle is finished charging via an external charging source (e.g., a charging station), a charging plug is removed, the vehicle is being driven or controlled, etc. If yes at 810, the control method 800 proceeds to 812. Otherwise, if no at 810, the control method 800 returns to 806.

At 812, the control module 110 opens or otherwise disables the switching devices (e.g., the MOSFETs 332, 334, 336, 338) in the stage 326 of the power converter 302. The control method 800 then proceeds to 814, where the control module 110 controls the switching device 308 of FIG. 3 to close. Then, the control method 800 proceeds to 816 and 818.

At 816, the control module 110 monitors one or more battery characteristics associated with the mixed chemistry battery assembly 306, as explained above. Then, at 818, the control module 110 controls the switching devices (e.g., the MOSFETs 354, 356, 358, 360, 364, 366) in the stage 328 of the power converter 302 based on the monitored battery characteristic(s). The control method 800 then proceeds to 820. At 820, the control module 110 determines whether to operate (e.g., continue to operate) the power system 100 in an energy movement mode or control. If yes at 820, the control method 800 returns to 816. Otherwise, if no at 820, the control method 800 proceeds to 804.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A power system for controlling power transfer in a vehicle, the power system comprising:
a multifunctional direct current-direct current (DC-DC) power converter configured to couple between a power source and a mixed chemistry battery assembly having a first battery module with a first chemistry and a second battery module with a second chemistry different than the first chemistry, the power converter including a first stage configured to couple to the power source and a second stage configured to couple to the mixed chemistry battery assembly, the second stage including at least one branch having an inductance;
a switching device coupled between the at least one branch of the power converter and a node between the first battery module and the second battery module of the mixed chemistry battery assembly; and
a control module configured to selectively control the switching device to cause the power converter to operate in a first mode in which the at least one branch of the power converter is coupled across the mixed chemistry battery assembly and a second mode in which the at least one branch of the power converter is coupled to the node between the first battery module and the second battery module of the mixed chemistry battery assembly.

2. The power system of claim 1, wherein the second stage includes a transformer coupled between the at least one branch and the first stage.

3. The power system of claim 2, wherein:
the switching device is a first switching device;
the first stage includes a plurality of second switching devices coupled between the transformer and the power source; and
the control module configured to open the plurality of second switching devices when the power converter to operating in the second mode.

4. The power system of claim 2, wherein:
the at least one branch is a first branch and the inductance is a first inductance;
the second stage includes a second branch having a second inductance; and
the switching device is coupled between the first and second branches and the node of the mixed chemistry battery assembly.

5. The power system of claim 2, wherein:
the at least one branch is a first branch and the inductance is a first inductance; and
the second stage includes a second branch having a second inductance and a third branch having a third inductance.

6. The power system of claim 5, wherein the switching device is coupled between the first, second and third branches and the node of the mixed chemistry battery assembly.

7. The power system of claim 5, wherein the switching device is coupled between the first and second branches and the third branch and the node of the mixed chemistry battery assembly.

8. The power system of claim 7, wherein the power converter is configured to simultaneously operate in the first mode and the second mode.

9. The power system of claim 1, wherein the control module configured to move the switching device to a first position to cause the power converter to operate in the first mode and to move the switching device to a second position to cause the power converter to operate in the second mode.

10. The power system of claim 1, wherein the control module configured to open the switching device to cause the power converter to operate in the first mode and to close the switching device to cause the power converter to operate in the second mode.

11. The power system of claim 1, wherein the power converter is configured to transfer power from one of the first battery module and the second battery module to the other one of the first battery module and the second battery module when operating in the second mode.

12. The power system of claim 11, wherein the power converter is configured to charge the first battery module and the second battery module of the mixed chemistry battery assembly via power from the power source when operating in the first mode.

13. The power system of claim 11, wherein the power converter is configured to discharge power from the first battery module and the second battery module of the mixed chemistry battery assembly to the power source when operating in the first mode.

14. A power system for controlling power transfer in a vehicle, the power system comprising
a high voltage power source;
a mixed chemistry battery assembly having a first battery module with a first chemistry and a second battery module with a second chemistry different than the first chemistry;
a multifunctional direct current-direct current (DC-DC) power converter including a first stage coupled to the high voltage power source and a second stage coupled to the mixed chemistry battery assembly, the second stage including at least one branch having an inductance and a transformer coupled between the at least one branch and the first stage;
a switching device coupled between the at least one branch of the power converter and a node between the first battery module and the second battery module of the mixed chemistry battery assembly; and
a control module configured to selectively control the switching device to couple the at least one branch across the mixed chemistry battery assembly to charge the first battery module and the second battery module via power from the high voltage power source and to couple the at least one branch to the node between the first battery module and the second battery module to transfer power from one of the first battery module and the second battery module to the other one of the first battery module and the second battery module.

15. The power system of claim 14, wherein:
the switching device is a first switching device;
the first stage includes a plurality of second switching devices coupled between the transformer and the high voltage power source; and
the control module configured to open the plurality of second switching devices when power is transferred from one of the first battery module and the second battery module to the other one of the first battery module and the second battery module.

16. The power system of claim 15, wherein:
the at least one branch is a first branch and the inductance is a first inductance;
the second stage includes a second having a second inductance; and
the first switching device is coupled between the first and second branches and the node of the mixed chemistry battery assembly.

17. The power system of claim 15, wherein:
the at least one branch is a first branch and the inductance is a first inductance; and
the second stage includes a second having a second inductance and a third branch having a third inductance.

18. The power system of claim 17, wherein the first switching device is coupled between the first, second and third branches and the node of the mixed chemistry battery assembly.

19. The power system of claim 17, wherein:
the first switching device is coupled between the first and second branches and the third branch and the node of the mixed chemistry battery assembly; and
the power converter is configured to simultaneously charge the first battery module and the second battery module via power from the high voltage power source and transfer power from one of the first battery module and the second battery module to the other one of the first battery module and the second battery module.

20. A power system for controlling power transfer in a vehicle, the power system comprising:
a low voltage battery pack;
a mixed chemistry battery assembly having a first battery module with a first chemistry and a second battery module with a second chemistry different than the first chemistry;
a multifunctional direct current-direct current (DC-DC) power converter configured to couple between the low voltage battery pack and the mixed chemistry battery assembly, the power converter including a first stage coupled to the low voltage battery pack and a second stage isolated from the first stage and coupled to the mixed chemistry battery assembly, the second stage including at least one branch having an inductance;
a switching device coupled between the at least one branch of the power converter and a node between the first battery module and the second battery module of the mixed chemistry battery assembly; and
a control module configured to selectively control the switching device to couple the at least one branch across the mixed chemistry battery assembly to discharge power from the first battery module and the second battery module to the low voltage battery pack and to couple the at least one branch to the node between the first battery module and the second battery module to transfer power from one of the first battery module and the second battery module to the other one of the first battery module and the second battery module.
